(19) United States
(12) Patent Application Publication
(10) Pub. No.: US 2026/0321113 A1
(43) Pub. Date: Oct. 15, 2026

(54) SURVEILLANCE UNITS INCLUDING MOUNTING DEVICES

(71) Applicant: LiveView Technologies, LLC, American Fork, UT (US)

(72) Inventors: James P. Bangerter, Saratoga Springs, UT (US); Michael J. Gleason, Orem, UT (US)

(21) Appl. No.: 19/543,501

(22) Filed: Feb. 18, 2026

Related U.S. Application Data
(60) Provisional application No. 63/788,266, filed on Apr. 14, 2025.

(51) Int. Cl. G08B 13/196

(52) U.S. Cl. CPC G08B 13/19632; G08B 13/19621

(57) ABSTRACT

Various embodiments relate to surveillance units and to clamping devices for attaching a head unit of the surveillance unit to a mast of the surveillance unit. A surveillance unit includes a portable trailer, a mast coupled to the portable trailer, a head unit coupled to the mast, the head unit comprising one or more cameras configured to capture camera data of an environment surrounding the surveillance unit, and a mounting device securing the head unit to the mast. The mounting device comprises a frame configured to be removably disposed around the mast, the frame comprising at least one channel circumferentially extending around at least a portion of a circumference of the frame, and a clamping device comprising a pin and a handle, the clamping device configured to attach the mounting device to the mast. Related devices and methods are also disclosed.

### CROSS-REFERENCE TO RELATED APPLICATION

This application claims the benefit of the filing date of U.S. Provisional Patent Application Ser. No. 63/788,266, filed Apr. 14, 2025, for “MOUNTING DEVICES AND ASSOCIATED SYSTEMS,” the entire disclosure of which is hereby incorporated herein by this reference.

### TECHNICAL FIELD

This disclosure relates generally to mounting devices, and more specifically to mounting devices including a clamp for securing a head unit to a mast (e.g., of a surveillance unit, such as a mobile surveillance unit), and to related surveillance units, systems, and methods.

### BACKGROUND

Recent years have witnessed significant growth in both hardware and software within the field of mobile security. A prime example of these advancements is mobile surveillance units (MSUs), which can be deployed across diverse environments to provide on-demand security monitoring and deterrence.

### SUMMARY

Embodiments disclosed herein include a surveillance unit comprising a portable trailer, a mast coupled to the portable trailer, a head unit coupled to the mast, the head unit comprising one or more cameras configured to capture camera data of an environment surrounding the surveillance unit, and a mounting device securing the head unit to the mast. The mounting device comprises a frame configured to be removably disposed around the mast, the frame comprising at least one channel circumferentially extending around at least a portion of a circumference of the frame, and a clamping device comprising a pin and a handle, the clamping device configured to attach the mounting device to the mast.

Additional embodiments include a device comprising a mounting device for securing a head unit of a surveillance unit to a mast. The mounting device comprises a frame configured to be removably disposed around the mast, the frame comprising a first portion, a second portion, a third portion, the second portion between the first portion and the third portion, a first channel between the first portion and the second portion, the first channel extending around at least a portion of a circumference of the frame, and a second channel between the second portion and the third portion, the second channel extending around the at least a portion of the circumference of the frame. The mounting device further comprises a clamping device configured to tighten the mounting device to the mast.

In some embodiments, a method of attaching a head unit to a mast of a surveillance unit comprises sliding a mounting device attached to a head unit of a surveillance unit over an end of a mast of the surveillance unit. The mounting device comprises a frame configured to be removably disposed around the mast, the frame comprising at least one channel circumferentially extending around at least a portion of a circumference of the frame, and a clamping device comprising a pin and a handle, the clamping device configured to attach the mounting device to the mast. The method further comprises tightening the clamping device to fasten the mounting device around the mast

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

FIG. 1 is a simplified perspective view of a surveillance unit, in accordance with various embodiments of the disclosure.

FIG. 2A is a simplified perspective view of a head unit, in accordance with various embodiments of the disclosure.

FIG. 2B is a simplified perspective view of another head unit, in accordance with various embodiments of the disclosure.

FIG. 3A and FIG. 3B are simplified perspective views of a mounting device including a clamping device.

FIG. 4A is a simplified perspective view of a mounting device including a clamping device from a first perspective, in accordance with various embodiments of the disclosure.

FIG. 4B is a simplified perspective view of the mounting device of FIG. 4A from a second perspective, in accordance with various embodiments of the disclosure.

FIG. 4C is a simplified cross-sectional view of the mounting device of FIG. 4A and FIG. 4B, in accordance with various embodiments of the disclosure.

FIG. 5 is a simplified flow chart illustrating a method of attaching a head unit to a mast of a surveillance unit with a mounting device, in accordance with various embodiments of the disclosure.

### DETAILED DESCRIPTION

Referring in general to the accompanying drawings, various embodiments of the disclosure are illustrated to show example embodiments related to mounting devices, which may be attached to a mast of a surveillance unit to facilitate securely attaching a head unit of the surveillance unit to the mast. It should be understood that the drawings presented are not meant to be illustrative of actual views of any particular portion of an actual circuit, device, system, or structure, but are merely representations which are employed to more clearly depict various embodiments of the disclosure.

The following provides a more detailed description of the present disclosure and various representative embodiments thereof. In this description, functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

The present disclosure utilizes a variety of terms to describe features and advantages of one or more embodiments of a mounting device for attaching a head unit of a security unit to a mast of the surveillance unit. Additional detail will now be provided regarding some of these terms. It will be appreciated that this description of these terms is not the complete or full meaning of these terms, but is provided as an aid in the following description. Additional features of the terms used herein may be drawn from examples and other embodiments described herein.

In one or more embodiments, a “surveillance unit” may include a mobile surveillance unit (or a “mobile unit” or a “mobile security unit”) and may refer to a security and/or surveillance system, device, or set of devices that form a cohesive unit to surveil a designated area. For example, a surveillance unit may be a security trailer or other portable device with surveillance components (e.g., cameras, lights, measurement sensors) and computational components for capturing, storing, processing, and/or providing surveillance data at a deployed location. In some implementations, a surveillance unit includes alert or output components (e.g., lights, speakers, sirens) for deterring malicious actions at the deployed location or against the mobile unit.

The present disclosure relates to mounting devices for securely attaching a head unit of a surveillance unit (e.g., a mobile surveillance unit) to a mast of the surveillance unit. The surveillance unit may include a portable trailer, a mast coupled to the portable trailer, and a head unit coupled to the mast. The head unit may include one or more cameras and/or one or more sensors configured to capture camera data and/or sensor data of an environment surrounding the surveillance unit. A mounting device may facilitate mounting the head unit to the mast.

The mounting device may include a frame configured to be removably disposed around the mast. In some embodiments, the frame includes a first portion, a second portion, and a third portion, the second portion between the first portion and the third portion. The frame may include at least one channel circumferentially extending around at least a portion of a circumference of the frame. In some embodiments, the frame includes a first channel between the first portion and the second portion, and a second channel between the second portion and the third portion. The first channel and the second channel may extend through the wall of the frame. In some embodiments, the frame further includes a vertical channel in the second section and extending between the first channel and the second channel. The vertical channel may extend through the wall of the frame.

The mounting device further includes a clamping device comprising a pin and a handle, the mounting device configured to attach the clamping device to the mast. In some embodiments, the mounting device includes a first arm and a second arm (also referred to as a “first flange” and a “second flange,” respectively) extending from the frame, such as from the second portion of the frame. The first arm and the second arm each include an aperture configured to receive the pin. The pin may be threaded and configured to facilitate tightening the mounting device around the mast, such as by biasing the first arm towards the second arm. For example, nuts or other biasing means may facilitate tightening the clamping device around the mast by biasing the first arm and the second arm towards one another.

In some embodiments, the first channel and the second channel may facilitate providing sufficient relief to the frame such that when the clamping device is not tightened (e.g., the first arm and the second arm are not biased towards one another), the mounting device may be slidably attached to the mast. Responsive to tightening the clamping device (e.g., by biasing the first arm and the second arm towards one another), the frame of the mounting device may be securely mounting around the mast. In some embodiments, an entire inner diameter of the frame contacts the mast around substantially an entire circumference of the mast. For example, the first channel and the second channel may facilitate substantially an entire inner diameter of the frame contacting and tightening against the mast. Contacting the entire circumference of the mast facilitates clamping the mounting device around the mast while reducing and/or preventing movement and rotation of the head unit and maintaining a desired range of rotation (e.g., during setup) of the head unit. In addition, the mounting device may facilitate mourning the head unit to the mast and reducing and/or preventing vibration (e.g., wobbling) or undesired rotation of the head unit during operation (e.g., in windy conditions) compared to conventional mounting devices.

Although various embodiments are described herein with reference to security and/or surveillance systems and/or mobile security and/or mobile surveillance units, the present disclosure is not so limited, and the embodiments may be generally applicable to any system and/or device that may or may not include security and/or surveillance systems and/or units. Further, although some embodiments are disclosed with reference to a mobile unit, the disclosure is not so limited, and a person having ordinary skill will understand that various embodiments may be applicable to other systems and devices, such as stationary units (e.g., a unit coupled to a stationary pole (e.g., a light pole), a structure (e.g., of a business or a residence), a tree, etc.). Embodiments of the disclosure will now be explained with reference to the accompanying drawings.

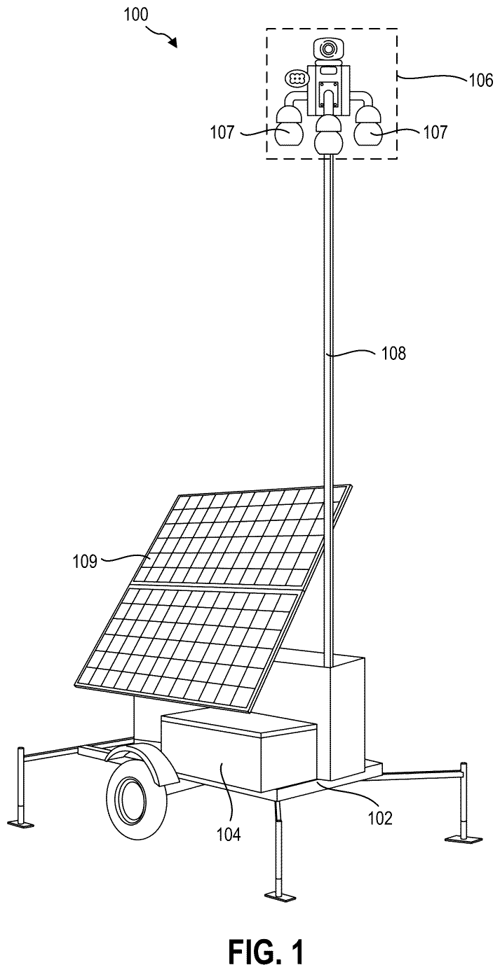

FIG. 1 is a simplified perspective view of an embodiment of a system including a surveillance unit 100, in accordance with various embodiments of the disclosure. The surveillance unit 100, which may also be referred to herein as a “mobile unit,” a “mobile surveillance unit,” a “mobile security unit,” an “MSU,” a “live unit,” a “physical unit,” or some variation thereof, may be configured to be positioned in an environment (e.g., a parking lot, a roadside location, a construction zone, a concert venue, a sporting venue, a school campus, without limitation). In some embodiments, the surveillance unit 100 includes one or more sensors (e.g., cameras, weather sensors, motion sensors, noise sensors, without limitation) and one or more output devices (e.g., lights, speakers, electronic displays, without limitation). The surveillance unit 100 may also include at least one storage device (e.g., internal flash media, a network attached storage device, or any other suitable electronic storage device), which may be configured for receiving and storing data (e.g., video, images, audio, without limitation) captured by one or more sensors of the surveillance unit 100.

In some embodiments, the surveillance unit 100 includes a mobile security/surveillance unit. For example, the mobile surveillance unit may be configured to be transported to a desired location and deployed at the desired location. In these and other embodiments, the surveillance unit 100 may include a portable trailer 102, a storage box 104, and a mast 108 coupled to a head unit 106 which may include, for example, one or more batteries, one or more cameras, controllers/processors or other electronics, one or more lights, one or more speakers, and/or one or more microphones. In some embodiments, the surveillance unit 100 is not a mobile surveillance unit.

During transport or storage of the surveillance unit 100, one or more components of the surveillance unit 100 may be removed from the surveillance unit 100, the mast 108, or the head unit 106. In some embodiments, the mast 108 is an extendable or deployable mast and may be extended or deployed at the time of deployment of the surveillance unit 100 in a field location. The mast 108 supports the head unit 106 and may include an extendable pole that is retracted while the surveillance unit 100 is being transported and extended when the surveillance unit 100 is secured at a deployed location. Upon deployment of the surveillance unit 100, the mast 108 may be connected to the portable trailer 102 and/or storage box 104 at a first end, and the head unit 106 may be positioned at an elevated position at a second, opposite end of mast 108. According to some embodiments, the first end of mast 108 may be proximate to the storage box 104 and the second, opposite end of mast 108 may be proximate, and possibly adjacent, to the head unit 106. More specifically, in some embodiments, the head unit 106 may be coupled to the mast 108 at an end opposite to an end of the mast 108 proximate to storage box 104.

The portable trailer 102 may be configured to facilitate transporting the surveillance unit 100. The storage box 104 may be configured to facilitate storage of one or more components of the surveillance unit 100, such as one or more primary batteries. The storage box 104 may also be configured to carry one or more power sources in addition to the primary batteries, such as generators (e.g., fuel cell generators).

In some examples, the surveillance unit 100 may include one or more primary batteries (e.g., within storage box 104) and one or more secondary batteries (e.g., within head unit 106). In these embodiments, a primary battery positioned in the storage box 104 may be coupled to a load and/or a secondary battery positioned within the head unit 106 via, for example, a cord reel.

In some embodiments, the surveillance unit 100 includes at least one computing device and/or other electronics powered by the one or more batteries. In some embodiments, valuable devices (e.g., hardware) may be securely housed in storage box 104 and in data communication with the head unit 106. For example, the head unit 106 may include one or more sensors or one or more output devices, and a computing device (e.g., in the head unit 106 or the storage box 104) may receive data from the one or more sensors and/or transmit instructions to the one or more output devices. As described above, in some embodiments, the storage box 104 securely houses one or more hardware storage devices. The one or more storage devices may be in data communication with and/or integrated with the one or more computing devices.

In some embodiments, the surveillance unit 100 may also include one or more power sources and/or power supplies. For example, the surveillance unit 100 may include or be in electrical communication with one or more solar panels 109, which may provide power to one or more batteries of the surveillance unit 100. More specifically, according to some embodiments, one or more solar panels 109 may provide power to a primary battery within storage box 104. In some embodiments, the surveillance unit 100 may also include other power sources, such as one or more generators (e.g., fuel cell generator or other power generators). For example, storage box 104 may include a fuel cell generator and/or another power generator.

The head unit 106 may include one or more sensors, visible spectrum cameras, thermal cameras, infrared (IR) cameras, IR sensors, and processing components (e.g., computing devices) that capture, process, and store surveillance data. In some embodiments, the head unit 106 includes one or more cameras 107. The cameras 107 may each include one or more thermal cameras, one or more visible cameras, an ultraviolet camera, a hyperspectral camera, and/or one or more other cameras. Non-limiting examples of thermal cameras include an infrared (IR) camera, a short-wave infrared (SWIR) camera, a long-wave infrared (LWIR) camera, a LWIR detection sensor, or another type of infrared camera. In some embodiments, the visible cameras include red green blue (RGB) cameras. In some embodiments, at least one of (e.g., each of) the cameras 107 includes a visible camera (e.g., an RGB camera) and a thermal camera and may be referred to as a “bi-spectral camera.” In some embodiments, the cameras 107 are visible spectrum cameras.

The head unit 106 may include hardware and software computing elements that allow the surveillance unit 100 to serve as an edge unit. In some embodiments, the head unit 106 also includes input and output devices, such as one or more lights (e.g., flood lights, strobe lights, LED lights, or other lights), speakers (e.g., loudspeakers, one-way speakers, two-way public address (PA) speaker systems, or any other suitable speaker), microphones, display devices (e.g., digital display devices), and/or other suitable output devices. In some embodiments, some components of the head unit 106 may also be located elsewhere on the surveillance unit 100, such as in the storage box 104. As described above, the head unit 106 may also include batteries or other power components. In some embodiments, the head unit 106 is referred to as a “live unit.”

In operation, the cameras 107 capture image data and/or video data comprising images and/or videos of the surveillance unit 100 and/or of a proximity of the surveillance unit 100. Based on the image data and/or the video data captured by the camera(s) 107, an alert system of the surveillance unit 100 may activate one or more alert protocols, which may include lights, speakers, and/or one or more other output devices on the surveillance unit 100.

In some embodiments, the head unit 106 includes one or more sensors configured to capture data indicative of one or more conditions in the environment proximate the surveillance unit 100.

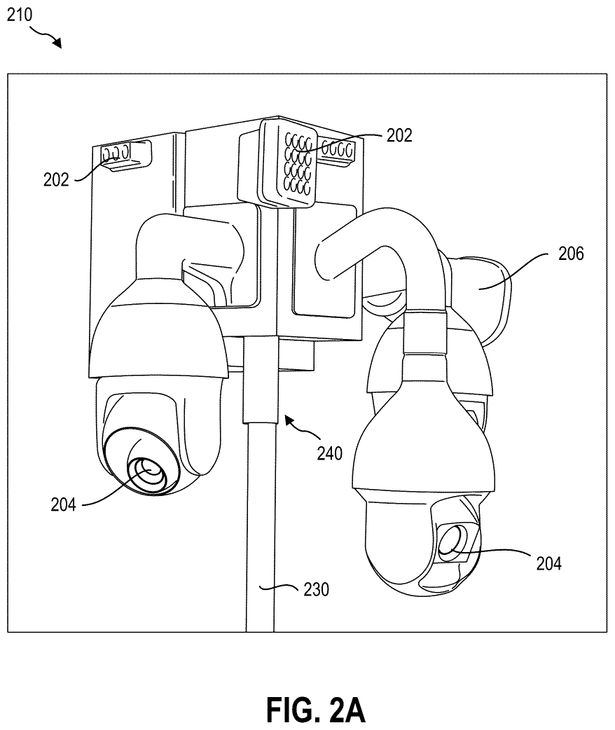

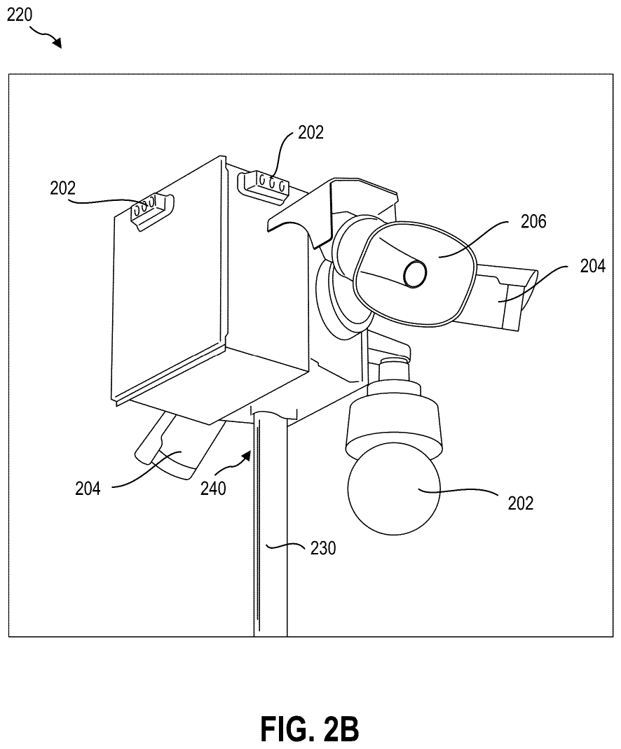

Non-limiting examples of the surveillance unit 100 are shown in FIG. 2A and FIG. 2B. FIG. 2A is a simplified perspective view of a head unit 210 of a surveillance unit 100 (FIG. 1), in accordance with various embodiments of the disclosure. FIG. 2B is a simplified perspective view of another head unit 220 of a surveillance unit 100 (FIG. 1), in accordance with various embodiments of the disclosure. The head units 210, 220 may correspond to or replace the head unit 106 of the surveillance unit 100. With reference to FIG. 2A, the head unit 210 (e.g., of surveillance unit 100) may be attached to a mast 230 and may include a number of lights 202, a number of cameras 204, and a speaker 206. With reference to FIG. 2B, the head unit 220 (e.g., of surveillance unit 100) may be attached to the mast 230 and may include a number of lights 202, a number of cameras 204, and a speaker 206. According to various embodiments, a mounting device, as described herein, may couple the head units 210, 220 to the mast 230 at a position noted by reference numeral 240. For example, the head units 210, 220 may be attached to a top end of the mast 230.

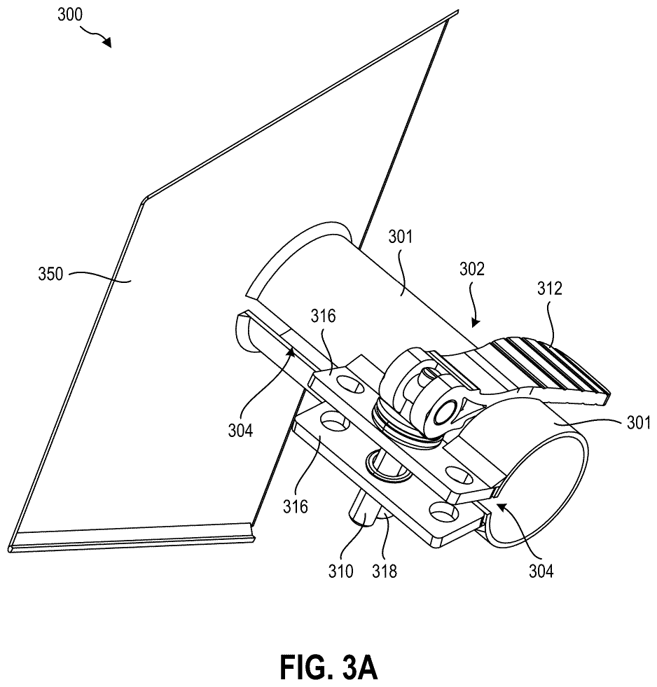

FIG. 3A is a simplified perspective view of a mounting device 300; and FIG. 3B is another simplified perspective view of the mounting device 300 coupling a head unit 350 to a mast 352. With reference to FIG. 3A and FIG. 3B, the mounting device 300 includes frame 301 and a clamping device 302. The frame 301 includes a slot or channel 304 extending vertically from one (bottom) end of the frame 301 to another (top) end of the frame 301. The clamping device 302 includes a pin 310 and a handle 312. The clamping device 302 may include brackets 316 extending from the frame 301. The pin 310 may extend through apertures (e.g., openings) in the brackets 316 to facilitate tightening the clamping device 302 and securing the frame 301 around a mast (e.g., mast 108, 230).

As shown in FIG. 3B, the mounting device 300 may couple a head unit 350 (only a portion of which is illustrated) to a mast 352. In some embodiments, the mounting device 300 is directly coupled to or integral with the head unit 350. For example, the mounting device 300 may be welded to the head unit 350, such as at weld 320. The channel 304 may be configured such that the frame 301 opens to a larger inner diameter than an outer diameter of the mast 352 to facilitate attaching the frame 301 over the mast 352 to a desired location (e.g., such as by sliding) prior to tightening the mounting device 300 around the mast 352 with the clamping device 302. With reference to FIG. 3A and FIG. 3B, the pin 310 may be threadable to facilitate tightening the frame 301 of the mounting device 300 around the mast 352. For example, to secure the frame 301 around the mast 352, the brackets 316 may be biased towards one another, such as by applying tension with a nut 318. Tightening the mounting device 300 around the mast 352 may include extending the pin 310 through the apertures in the brackets 316 and applying tension to the pin 310, such as with the nut 318.

Due to various factors, the mounting device 300 suffers from uneven clamping engagement, which may cause undesired movement (e.g., wobbling) of a head unit 350 (e.g., in windy conditions). As one example, the channel 304, which may facilitate installing the mounting device 300 over the mast 352 prior to tightening the clamping device 302, may cause the frame 301 not to be integral around an entire circumference of the mast 352. In other words, the channel 304 may define an opening (or gap) in the circumference of the frame 301 and the frame 301 may not contact an entire circumference of the mast 352. Since the mounting device 300 is welded to the head unit 350 at the weld 320 at the upper end of the mounting device 300, tightening of the clamping device 302 may not evenly tighten the frame 301 around the mast 352. Rather, tightening the clamping device 302 may tighten a lower portion of the frame 301 around the mast 352 more than the upper portion, which may undesirably reduce engagement of the frame 301 with the mast 352 along the length of the mast 352. In some scenarios, a head unit (e.g., the head unit 350) may even rotate unintentionally, which may cause the field of view of the cameras (e.g., cameras 107, 204) to move out of an area of interest.

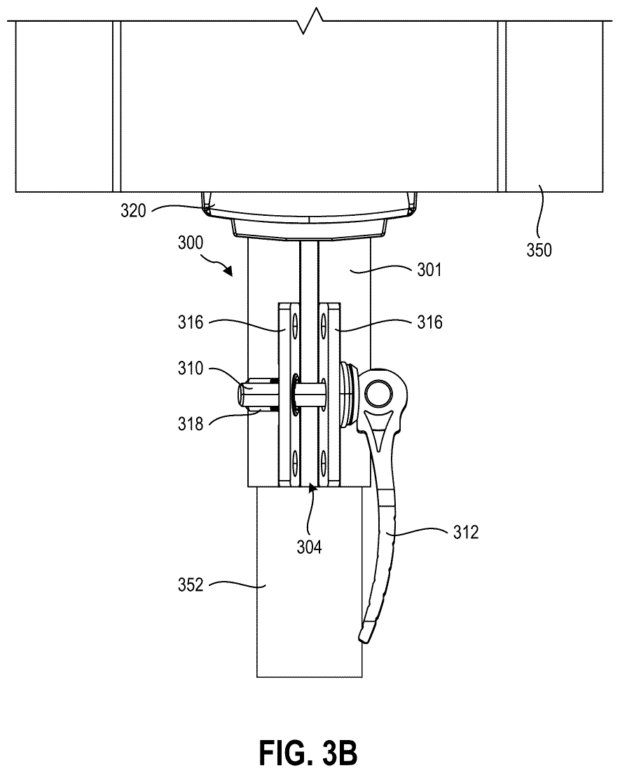

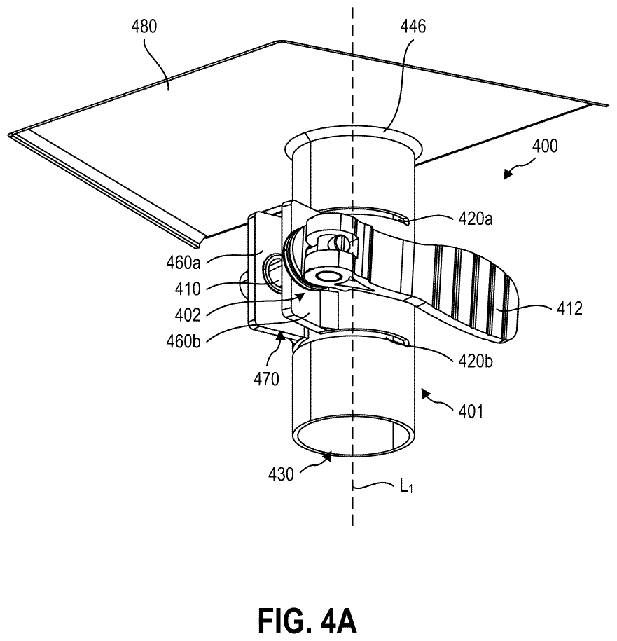

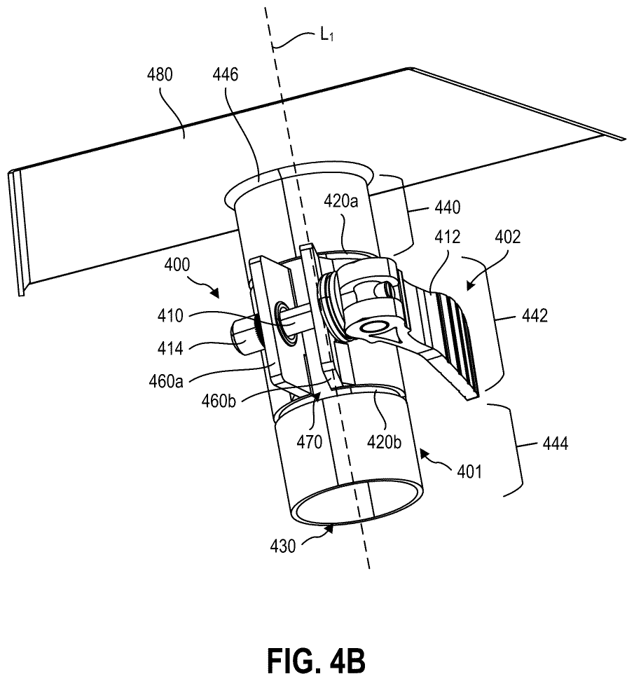

FIG. 4A is a simplified perspective view of a mounting device 400 from a first perspective; and FIG. 4B is another simplified perspective view of the mounting device 400 from a second perspective, in accordance with various embodiments of the disclosure. The mounting device 400 may be configured to facilitate mounting a head unit 480 (e.g., head unit 106, 210, 220) to a mast (e.g., mast 108, 230). As shown in FIG. 4A and FIG. 4B and as described in additional detail herein, the mounting device 400 includes a compliant cutout (e.g., first channel 420a, second channel 420b) designed to provide greater engagement and clamping force around the mast (e.g., mast 108, 230) compared to the mounting device 300 and/or compared to conventional mounting devices.

In some embodiments, the mounting device 400 is integral with the head unit 480. In some embodiments, the mounting device 400 is integrally attached or coupled to the head unit 480, such as at joint 446. For example, the mounting device 400 may be welded to the head unit 480 at the joint 446 (e.g., the joint 446 may comprise a weld). In other embodiments, the head unit 480 includes a cylindrical portion that extends into an opening at an end of the mounting device 400. The head unit 480 may include one or more cameras (e.g., cameras 107, 204), one or more lights (e.g., lights 202), one or more speakers (e.g., speakers 206), and/or one or more other output devices, as described above.

With reference to FIG. 4A and FIG. 4B, the mounting device 400 includes a frame 401 and a clamping device 402. The frame 401 may exhibit a substantially circular cross-sectional shape and may be configured to be removably attached and disposed around a mast (e.g., mast 108, 230) to facilitate mounting the head unit 480 to the mast. The clamping device 402 includes a pin 410 and a handle 412 (best seen in the view of FIG. 4B). In some embodiments, the pin 410 is threaded; or at least one end of the pin 410 (e.g., opposite the handle 412) is threaded. In some embodiments, a nut 414 threadably engages with an end of the pin 410 to hold the pin 410 in place and maintain tension (compression) of the clamping device 402 around a mast (e.g. mast 108).

The clamping device 402 may include arms including a first arm 460a and a second arm 460b extending from the frame 401 (or from a cylindrical portion of the frame 401). The first arm 460a and the second arm 460b may also be referred to as a respective “first bracket” and “second bracket” and/or a respective “first flange” and “second flange,” and may collectively be referred to as arms 460. The arms 460 may include an aperture 462 (FIG. 4C) through which the pin 410 extends. In operation, to tighten the mounting device 400 (and the attached head unit 480) to the mast, pin 410 is inserted through the aperture in the arms 460. The clamping device 402 includes a means for biasing the first arm 460a and the second arm 460b towards one another. For example, as described above, the first arm 460a and the second arm 460b may be biased towards one another by tightening the nut 414 (such as by rotating the nut 414 relative to the handle 412). For example, the nut 414 may be tightened while holding the handle 412 in a given position to tighten the clamping device 402 around the mast.

The frame 401 may include a longitudinal axis L₁, which may correspond to a longitudinal axis of the mast 108, 230. For example, when the mounting device 400 is attached to a mast, the longitudinal axis L₁ and the longitudinal axis of the mast may be parallel to one another and/or may be colinear (e.g., the same). In addition, when the mounting device 400 is attached to the mast, the frame 401 and the mast may be concentric. In some embodiments, when the mounting device 400 is attached to the mast, the frame 401 extends around and contacts substantially all surfaces of the mast along the circumference of the mast along the length of the frame 401.

The frame 401 may include a first portion 440, a second portion 442 adjacent to the first portion 440, and a third portion 444 adjacent to the second portion 442. The second portion 442 may be between the first portion 440 and the third portion 444. The first portion 440, the second portion 442, and the third portion 444 may be vertically spaced from one another in the longitudinal direction (e.g., the direction of the longitudinal axis L₁). In some embodiments, the first portion 440 is closer to the head unit 480 than the second portion 442 and the third portion 444. The first portion 440 may contact the head unit 480, such as at the joint 446.

The mounting device 400 may include at least one channel 420 extending around at least a portion of a circumference of the frame 401. For example, with collective reference to FIG. 4A and FIG. 4B, the mounting device 400 includes slots or channels 420 including a first channel 420a and a second channel 420b, which may collectively be referred to herein as channels 420. The channels 420 may extend laterally (i.e., compared to the vertical channel of mounting device 300) around the mounting device 400 (e.g., around at least a portion of a circumference of the mounting device 400). In other words, the channels 420 may extend around at least a portion of the circumference of the mounting device 400, such as around at least a portion of the frame 401. The channels 420 may extend at least partially around the cylindrical portion of frame 401 (e.g., ½ of the way around, ⅓ of the way around, ⅔ of the way around, or any other suitable configuration). In some embodiments, the channels 420 extend around only a portion of the circumference of the frame 401. In other words, the channels 420 may not extend substantially around an entire circumference of the frame 401. The first channel 420a may be substantially the same as the second channel 420b. In some embodiments, the first channel 420a and the second channel 420b extend substantially the same amount (e.g., the same amount) around the circumference of the frame 401. In other embodiments, the channels 420 extend around an entire circumference of the frame 401.

Each channel 420 may individually extend around from about 90° to about 270° of the circumference of the frame 401, such as from about 90° to about 120°, from about 120° to about 150°, from about 150° to about 180°, from about 180° to about 210°, from about 210° to about 240°, or from about 240° to about 270° around the circumference. In some embodiments, the channels 420 extend substantially the same amount around the circumference of the frame 401. In some embodiments, each channel 420 extends from about 150° to about 210° around the circumference of the frame 401. In some embodiments, each channel 420 extends from about 210° to about 270°, such as about 240° around the circumference of the frame 401. In some embodiments, the first channel 420a and the second channel 420b are circumferentially aligned with one another.

The first channel 420a may be longitudinally between the first portion 440 and the second portion 442. The second channel 420b may be longitudinally between the second portion 442 and the third portion 444. In some embodiments, the second portion 442 of the frame 401 is longitudinally between the first channel 420a and the second channel 420b. The first arm 460a and the second arm 460b may be between and vertically extend from the first channel 420a and the second channel 420b. In some embodiments, the first arm 460a and the second arm 460b are circumferentially centered with respect to the first channel 420a and the second channel 420b. In some embodiments, the first channel 420a circumferentially extends from the first arm 460a about a same circumferential amount (e.g., the same circumferential amount) as the first channel 420a circumferentially extends from the second arm 460b. Similarly, second channel 420b may circumferentially extend from the second arm 460b about a same circumferential amount (e.g., the same circumferential amount) as the second channel 420b circumferentially extends from the second arm 460b.

FIG. 4C is a simplified side cross-sectional view of the mounting device 400 showing only the frame 401, in accordance with various embodiments of the disclosure. With reference to FIG. 4C, the frame 401 may include a wall 450 including inner surfaces 452 defining an inner diameter D₁ and outer surface 454 defining an outer diameter D₂ larger than the inner diameter D₁. The inner diameter D₁ may correspond to the outer diameter of the mast. With collective reference to FIG. 4A through FIG. 4C, in some embodiments, the channels 420 extend through an entire width of the wall 450.

The channels 420 may provide improved contact between the frame 401 and the mast compared to conventional mounting devices. For example, when the mounting device 400 is attached to the mast (such as by tightening the clamping device 402), the inner surface 452 contacts substantially an entire circumference of the mast along the longitudinal length of the frame 401. The channels 420 may provide a relief to the frame 401 and allow substantially an entire inner circumference of the frame 401 to contact the mast when the clamping device 402 is tightened. In some embodiments, substantially all of the inner surface of the section portion 442 contacts the mast when the clamping device 402 is tightened. Further, the separation between the first portion 440 and the second portion 442 provided by the first channel 420a facilitates securely tightening at least the second portion 442 around the mast. By way of comparison, conventional mounting devices may include a channel or slot extending through the entire wall of the frame and along the longitudinal length of the mounting device such that the entire circumference of the mast is not contacted by the mounting device when the mounting device is attached to the mast.

With continued reference to FIG. 4A and FIG. 4B, the frame 401 includes an opening 430 for receiving, for example, a mast (e.g., mast 108 of a mobile surveillance unit (e.g., surveillance unit 100)). The frame 401 may include a vertical channel 470 (a vertically extending channel extending in the longitudinal direction) between the first arm 460A and the second arm 460B; however, in some embodiments, vertical channel 470 may not extend an entire height of frame 401. In some embodiments, the vertical channel 470 is integral with (e.g., contacts, extends between and is in communication with) the first channel 420a and the second channel 420b.

In some embodiments, the vertical channel 470 vertically extends (e.g., in the longitudinal direction) from the first channel 420a to the second channel 420b. For example, in some embodiments, only the second portion 442 includes the vertical channel 470 (i.e., the first portion 440 and the second portion 444 do not include the vertical channel 470). In some embodiments, the vertical channel 470 may extend through the entire wall 450 of the frame 401. In some such embodiments, the vertical channel 470 may not extend through an entire thickness of the wall 450. According to some embodiments, the frame 401 may be coupled to a head unit 480, such as at the joint 446. In some examples, the frame 401 and a body of head unit 480 may be a unitary piece of material (e.g., metal).

In contrast to conventional devices and the mounting device 300, the mounting device 400 provides a more evenly distributed and increased clamping engagement and/or clamping force, which may limit, or possibly prevent, movement and rotation of a head unit, while maintaining infinite range of rotation (e.g., during setup). For example, the first channel 420a and the second channel 420b may provide sufficient relief to the frame 401 to facilitate slidably attaching the frame 401 and the mounting device 400 to a mast when the clamping device 402 is loose. After sliding the mounting device 400 over the mast to a desired location, tightening the clamping device 402 may cause the inner surfaces 452 to contact the outer surfaces of the mast substantially along an entire circumference of the mast. Without being bound by any particular theory, it is believed that the first channel 420a and the second channel 420b facilitate attaching the mounting device 400 to the mast by causing the inner surface 452 to make contact with the entire circumference of the mast when the clamping device 402 is tightened. The first channel 420a and the second channel 420b may provide sufficient relief to facilitate opening the diameter of the opening 430 sufficient to slidably attach the mounting device 400 to the mast when the clamping device 402 is not tightened, but also facilitate substantial contact and clamping force around the mast when the clamping device 402 is tightened.

Accordingly, the mounting device 400 may be used to facilitate mounting the head unit 480 (corresponding to the head unit 106, 210, 220) to the mast (corresponding to mast 108, 230) of a surveillance unit (e.g., surveillance unit 100). The surveillance unit may be a mobile surveillance unit. In addition, the head unit 480 may include one or more cameras (e.g., visible cameras and/or thermal cameras), one or more speakers, one or more lights, and/or one or more other output devices. The head unit 480 may include one or more cameras configured to capture camera data (e.g., image data, video data) of an environment surrounding the surveillance unit. In some embodiments, the head unit and/or the surveillance unit includes processing circuitry for analyzing image and/or video data from the cameras to identify one or more objects of interest. For example, the head unit and/or the surveillance unit may include image processing circuitry, such as an object detector and/or an object tracker configured to identify and/or track objects of interest. Based on identified objects of interest, the head unit and/or the surveillance unit may generate an alarm and/or provide a notification to a user of the surveillance unit, such as to a remote location. In some embodiments, responsive to the alarm, the surveillance unit may activate one or more output devices, such as by providing an audible alarm and/or flashing lights.

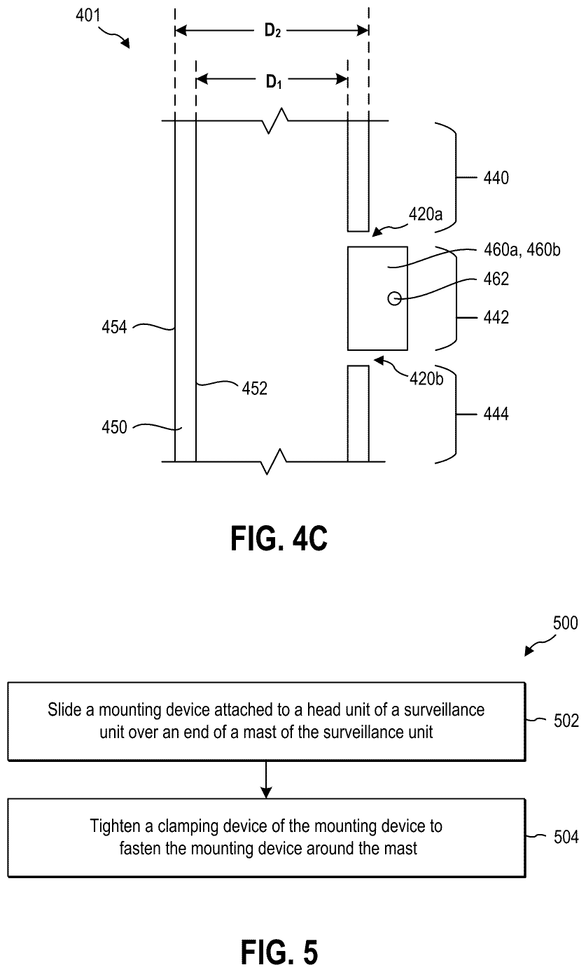

FIG. 5 is a simplified flow chart illustrating a method 500 of attaching a head unit to a mast of a surveillance unit with a mounting device (e.g., mounting device 400), in accordance with various embodiments of the disclosure. The method 500 may include sliding a mounting device attached to a head unit of a surveillance unit over an end of a mast of the surveillance unit, as shown in act 502. The surveillance unit may be the same as the surveillance unit 100 described above; and the head unit may include any of the head units 106, 210, 220 described above. The mounting device may be the same as the mounting device 400 described above.

After sliding the mounting device over the mast, the method 500 may include tightening a clamping device of the mounting device to fasten the mounting device around the mast, as shown in act 504. In some embodiments, tightening the clamping device facilitates contacting the mast with the mounting device around substantially an entire circumference of the mast.

In accordance with common practice, the various features illustrated in the drawings may not be drawn to scale. The illustrations presented in the disclosure are not meant to be actual views of any particular apparatus (e.g., device, system, etc.), but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. As used herein, “and/or” includes any and all combinations of one or more of the associated listed items.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, the term “approximately” or the term “about,” when used in reference to a numerical value for a particular parameter, is inclusive of the numerical value and a degree of variance from the numerical value that one of ordinary skill in the art would understand is within acceptable tolerances for the particular parameter. For example, “about,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

What is claimed:

1. A surveillance unit, comprising:
a portable trailer;
a mast coupled to the portable trailer;
a head unit coupled to the mast, the head unit comprising one or more cameras configured to capture camera data of an environment surrounding the surveillance unit; and
a mounting device securing the head unit to the mast, the mounting device comprising:
a frame configured to be removably disposed around the mast, the frame comprising at least one channel circumferentially extending around at least a portion of a circumference of the frame; and
a clamping device comprising a pin and a handle, the clamping device configured to attach the mounting device to the mast.

2. The surveillance unit of claim 1, wherein the at least one channel comprises a first channel and a second channel, each of the first channel and the second channel extending around at least a portion of the circumference of the frame.

3. The surveillance unit of claim 2, wherein the first channel and the second channel extend substantially a same circumferential amount around the circumference of the frame.

4. The surveillance unit of claim 1, wherein the at least one channel extends entirely through a wall of the frame.

5. The surveillance unit of claim 1, wherein the frame comprises a first portion, a second portion, and a third portion, the second portion between the first portion and the third portion.

6. The surveillance unit of claim 5, wherein the second portion includes a first arm and a second arm, the pin configured to extend through apertures in the first arm and the second arm.

7. The surveillance unit of claim 6, wherein the first arm is located substantially a same circumferential distance from an end of the at least one channel as the second arm.

8. The surveillance unit of claim 5, wherein the at least one channel comprises:
a first channel between the first portion and the second portion; and
a second channel between the second portion and the third portion.

9. The surveillance unit of claim 8, further comprising a first arm and a second arm, each longitudinally extending between the first channel and the second channel.

10. The surveillance unit of claim 8, further comprising a vertical channel longitudinally extending from the first channel to the second channel.

11. The surveillance unit of claim 10, wherein the vertical channel extends through an entire wall of the frame.

12. The surveillance unit of claim 1, further comprising a vertical channel longitudinally extending along a length of the mounting device.

13. The surveillance unit of claim 1, wherein the surveillance unit is a mobile surveillance unit.

14. The surveillance unit of claim 1, wherein the frame comprises a circular opening.

15. A device, comprising:
a mounting device for securing a head unit of a surveillance unit to a mast, the mounting device comprising:
a frame configured to be removably disposed around the mast, the frame comprising:
a first portion;
a second portion;
a third portion, the second portion between the first portion and the third portion;
a first channel between the first portion and the second portion, the first channel extending around at least a portion of a circumference of the frame; and
a second channel between the second portion and the third portion, the second channel extending around the at least a portion of the circumference of the frame; and
a clamping device configured to tighten the mounting device to the mast.

16. The device of claim 15, wherein the head unit comprises at least one camera configured to capture image data of an environment surrounding the surveillance unit.

17. The device of claim 15, wherein the first channel and the second channel extend through a wall of the frame.

18. The device of claim 15, wherein the clamping device comprises:
a first arm and a second arm extending from the second portion;
a pin extending through apertures in the first arm and the second arm; and
means for biasing the first arm and the second arm toward one another to tighten the mounting device.

19. The device of claim 15, further comprising a vertical channel extending through walls of the frame in the second portion and extending between the first channel and the second channel.

20. A method of attaching a head unit to a mast of a surveillance unit, the method comprising:
sliding a mounting device attached to a head unit of a surveillance unit over an end of a mast of the surveillance unit, the mounting device comprising:
a frame configured to be removably disposed around the mast, the frame comprising at least one channel circumferentially extending around at least a portion of a circumference of the frame; and
a clamping device comprising a pin and a handle, the clamping device configured to attach the mounting device to the mast; and
tightening the clamping device to fasten the mounting device around the mast.
